(19) United States
(12) Patent Application Publication
(10) Pub. No.: US 2011/0055508 A1
(43) Pub. Date: Mar. 3, 2011

(54) Information processing apparatus, data transfer method, and computer-readable recording medium

(75) Inventor: Yasuhiro Hattori, Kanagawa (JP)

(73) Assignee: Ricoh Company, Ltd.

(21) Appl. No.: 12/805,961

(22) Filed: Aug. 26, 2010

(30) Foreign Application Priority Data
Sep. 1, 2009 (JP) 2009-202004

(51) Int. Cl. G06F 12/00

(52) U.S. Cl. 711/165; 711/E12.001; 711/E12.002

(57) ABSTRACT

An information processing apparatus includes a first storage for storing pre-existing data including a program for operating the information processing apparatus; an input unit for inputting data into the information processing apparatus from outside via a recording medium; a detecting unit for detecting that a second storage is additionally installed in the information processing apparatus; a display unit for prompting input of the recording medium recording a data transfer program, when it is detected that the second storage is additionally installed; and a transfer unit for transferring the pre-existing data from the first storage to the second storage in accordance with the data transfer program, when the data transfer program recorded in the recording medium is input by the input unit. The transfer unit temporarily saves the pre-existing data in a save area in the recording medium before transferring the pre-existing data to the second storage unit.

### BACKGROUND OF THE INVENTION

1. Field of the Invention

The present invention relates to an information processing apparatus, a data transfer method, and a computer-readable recording medium.

2. Description of the Related Art

In recent years and continuing, there are widely known image forming apparatuses, which include plural functions such as those of a copier, a scanner, a printer, and a fax machine accommodated in a single body, and which have a high-volume storage device (e.g., an HDD). Before such image forming apparatuses became available in the market, memories were quite expensive. Therefore, copiers (without an HDD) having programs installed in a low-volume storage device (e.g., a ROM such as NAND-Flash) have been in widespread use. Such a low-volume storage device stores various programs for operating the copier and various kinds of system data (user information, setting information, various parameters, etc.).

In order to add a new function to such a copier (without an HDD), the following operations are performed. For example, an optional HDD that is a high-volume storage device is additionally installed in the copier. Then, the above-described programs and system data, which are stored in the ROM that is a low-volume storage device, need to be transferred to the additional HDD. The reason why an additional HDD is installed is that the low-volume ROM in the copier may not be able to provide the additional storage area that is needed for the new function. Specifically, the above-described programs and system data stored in the ROM of the copier are transferred to the additional HDD for the following reasons.
(1) When a function is added to an existing program, the size of the existing program increases, and the existing ROM in the copier may not be able to accommodate any more data.
(2) When a function is added to the copier, the system data size increases, and the existing ROM in the copier may not be able to accommodate any more data.
(3) The frequency of updating the system data may increase depending on the additional function, which may exceed the overwrite limit (life) of the NAND-Flash.

As described above, when a new function is added to a copier (without an HDD), it may not be possible to increase the storage space in the existing ROM any further. Therefore, the programs and system data need to be transferred from the existing ROM of the copier to the additional HDD.

Patent document 1 discloses an example of a technology of adding programs. Several control programs which are optional programs are installed in advance in the HDD of an image forming apparatus such as a copier or a printer, and encrypted data is recorded in an SD card having unique ID data. When the SD card is inserted in the image forming apparatus, the image forming apparatus performs calculation with the use of the ID data and'the encrypted data in the SD card and a predetermined function. Based on the calculation results, the image forming apparatus determines whether to allow or prohibit usage of each control program. As described above, the programs are preinstalled in the HDD, and therefore when an optional program is to be added, there is no need to add a memory card including a flash memory or to distribute data with a CD-ROM.

However, in recent years and continuing, security is being taken into consideration. For this purpose, programs and system data are often encrypted when stored in the HDD, to prevent data modification (which causes malfunction) and data leakage. Programs and system data are particularly subjected to encryption, while user data (such as image data) is not encrypted as much as programs and system data. A key used for encrypting the data can be generated in the image forming apparatus when an additional HDD is installed in the corresponding image forming apparatus. Therefore, in order to encrypt the information to be stored in an HDD, the programs cannot be preinstalled in a HDD that is built in the image forming apparatus in advance as in the invention of patent document 1.

Patent Document 1: Japanese Laid-Open Patent Application No. 2003-058486

### SUMMARY OF THE INVENTION

The present invention provides an information processing apparatus, a data transfer method, and a computer-readable recording medium, in which one or more of the above-described disadvantages are eliminated.

A preferred embodiment of the present invention provides an information processing apparatus, a data transfer method, and a computer-readable recording medium, with which programs and data stored in a low-volume storage device can be transferred to a high-volume storage device by a simple operation when installing an additional high-volume storage device.

According to an aspect of the present invention, there is provided an information processing apparatus including a first storage device configured to store pre-existing data including a program for operating the information processing apparatus; a data input unit configured to input data into the information processing apparatus from outside via a recording medium; a detecting unit configured to detect that a second storage device is additionally installed in the information processing apparatus; a display unit configured to prompt input of the recording medium storing a data transfer program, when the. detecting unit detects that the second storage device is additionally installed; and a data transfer unit configured to transfer the pre-existing data from the first storage device to the second storage device in accordance with the data transfer program, when the data transfer program stored in the recording medium is input by the data input unit, wherein the recording medium includes a save area in which the pre-existing data is temporarily saved, and the data transfer unit temporarily saves the pre-existing data in the save area before transferring the pre-existing data to the second storage unit.

According to an aspect of the present invention, there is provided a data transfer method performed by an information processing apparatus including a first storage device configured to store pre-existing data including a program for operating the information processing apparatus, the data transfer method including inputting data into the information processing apparatus from outside via a recording medium; detecting that a second storage device is additionally installed in the information processing apparatus; prompting input of the recording medium storing a data transfer program, when it is detected at the detecting that the second storage device is additionally installed; and transferring the pre-existing data from the first storage device to the second storage device in accordance with the data transfer program, when the data transfer program stored in the recording medium is input at the inputting, wherein the transferring includes temporarily saving the pre-existing data in a save area in the recording medium before transferring the pre-existing data to the second storage unit.

According to one embodiment of the present invention, an information processing apparatus, a data transfer method, and a computer-readable recording medium are provided, with which programs and data stored in a low-volume storage device can be transferred to a high-volume storage device by a simple operation when installing the additional high-volume storage device.

### BRIEF DESCRIPTION OF THE DRAWINGS

Other objects, features and, advantages of the present invention will become more apparent from the following detailed description when read in conjunction with the accompanying drawings, in which:

FIG. 1 illustrates an example of a hardware configuration of an image forming apparatus according to an embodiment of the present invention;

FIG. 2 illustrates an example of a hardware configuration (including an additional HDD) of the image forming apparatus according to an embodiment of the present invention;

FIG. 3 illustrates an example of a transfer media kit according to an embodiment of the present invention;

FIG. 4 is a flowchart of a process performed by the image forming apparatus according to an embodiment of the present invention;

FIG. 5 is a schematic diagram of a storage area before the additional HDD is installed; and

FIG. 6 is a schematic diagram of a storage area after the additional HDD is installed.

### DETAILED DESCRIPTION OF THE PREFERRED EMBODIMENTS

A description is given, with reference to the accompanying drawings, of embodiments of the present invention.

In the following description, the present invention is applied to an image forming apparatus which is one embodiment of an information processing apparatus.

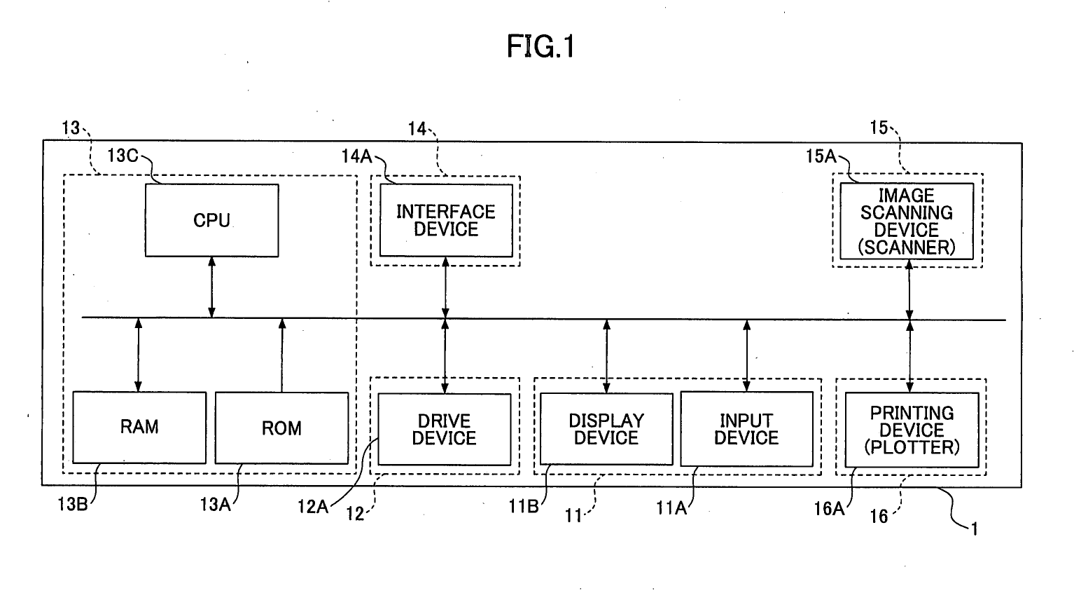

An image forming apparatus 1 according to an embodiment of the present invention is a copier (without an HDD) in which programs are installed in a low-volume ROM. FIG. 1 illustrates an example of a hardware configuration of the image forming apparatus 1 according to an embodiment of the present invention. The image forming apparatus 1 includes an operations panel 11, a storage medium I/F 12, a controller 13, a data communications I/F 14, a scanner 15, and a plotter 16, which are connected to each other.

The operations panel 11 includes an input device 11A and a display device 11B. The input device 11A includes hardware keys, and is used for inputting various operation signals into the main unit of the image forming apparatus 1. The display device 11B includes a display, and is used for displaying various information items relevant to image forming operations and for displaying a wizard screen page relevant to an additional HDD when installing the additional HDD.

The data communications'I/F 14 includes an interface device 14A which is an interface used for connecting the image forming apparatus 1 to data transmission paths such as a network or a fax transmission line.

A drive device 12A can read various kinds of data from a recording medium set in the drive device 12A via the storage medium I/F 12.

The controller 13 includes a ROM (Read Only Memory) 13A, a RAM (Random Access Memory) 13B, and a CPU (Central Processing Unit) 13C. The ROM 13A stores various programs that are executed'when the image forming apparatus 1 is activated or operated and various kinds of system data (system information, user information, setting information, various parameters, etc.). The RAM 13B is for temporarily holding the programs and system data loaded from the ROM 13A. Furthermore, the CPU 13C executes the programs that are temporarily held by the RAM 13B. When the controller 13 receives print data via the data communications I/F 14, the CPU 13C executes a program (PDL parser) that can interpret PDL (Page Description Language) that has been loaded from the ROM 13A into the RAM 13B. Then, the controller 13 interprets the print data and generates a bitmap. image.

The scanner 15 includes an image scanning device 15A that optically scans an original that is placed on the scanning surface and generates image data. The plotter 16 includes a printing device 16A that prints a bitmap image onto a recording sheet by an electrophotographic processing method. The image forming apparatus 1 that is an information processing apparatus according to an embodiment of the present invention implements functions such as a copy function with the above described hardware configuration.

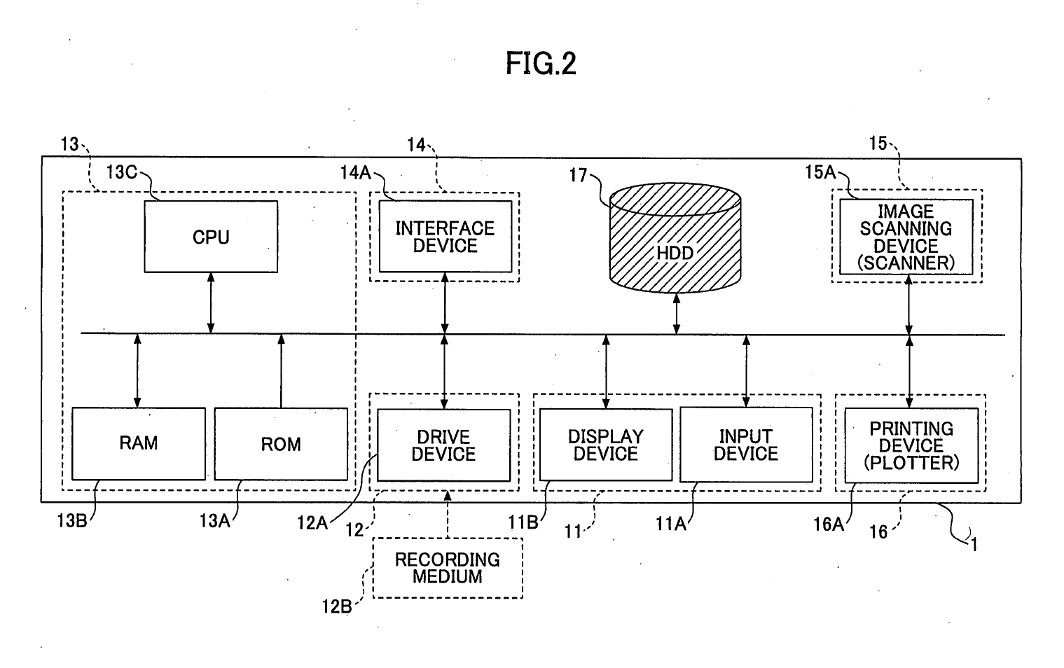

FIG. 2 illustrates an example of a hardware configuration (including an additional HDD) of the image forming apparatus 1 according to an embodiment of the present invention. The image forming apparatus 1 according to the present embodiment does not include a preinstalled HDD. Therefore, in order to add a new function, an additional HDD needs to be physically installed. FIG. 2 illustrates the image forming apparatus 1 of FIG. 1 with an additionally installed HDD 17.

After installing the additional HDD 17, programs and various data items are input (installed) in the image forming apparatus 1 via a recording medium (external recording medium) 12B. These programs and various data items are for providing a new function to be added to the image forming apparatus 1. The drive device 12A can read additional programs and additional system data (system data required for the additional programs) from the recording medium 12B set in the drive device 12A via the storage medium I/F 12. In the present embodiment, an SD memory card (hereinafter, “SD card”) which is a flash memory may be applied as the recording medium 12B. The SD card stores a data transfer program used for transferring data to the HDD 17. The data to be transferred to the HDD 17 includes the additional programs and additional system data as well as various programs (hereinafter, “existing programs”) and various kinds of system data (hereinafter, “existing system data”) that are stored in the ROM 13A. The SD card may be referred to as a transfer media kit used for adding a function and transferring data when an additional HDD is installed. Details are described below.

As described above, by using the SD card (transfer media kit) according to the present embodiment, the additional programs and additional system data are input to the additionally installed HDD 17 from the SD card (transfer media kit). Furthermore, by executing the data transfer program, the existing programs and existing system data stored in the ROM 13A are transferred to the HDD 17. The memory space that is needed for the additional function is not available in the ROM 13A, and therefore the existing programs and existing system data are transferred to the additionally installed HDD 17.

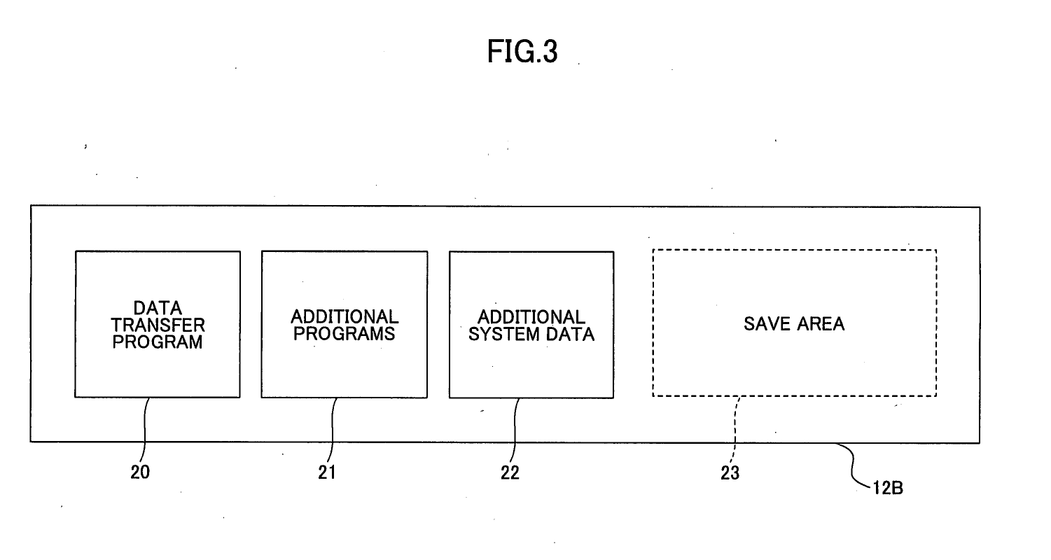

FIG. 3 illustrates an example of the transfer media kit according to an embodiment of the present invention. The transfer media kit 12B, which is implemented by the SD card, includes a data transfer program 20, additional programs 21, additional system data 22, and a save area 23.

The data transfer program 20 is for transferring the existing programs and existing system data from the ROM 13A to the HDD 17. The additional programs 21 correspond to the function programs for providing a new function that is to be additionally installed in the image forming apparatus 1. The additional system data 22 corresponds to system data that is needed for the function programs. The save area 23 is a storage area for temporarily saving the existing programs and existing system data in the ROM 13A.

When the power of the image forming apparatus 1 is turned on after installing the additional HDD 17, a device management unit of the image forming apparatus 1 detects the additional HDD 17, and the display device 11B displays a wizard screen page relevant to the additional HDD 17. The wizard screen page displays a message instructing to “insert the transfer media kit 12B when adding a new program”. The user inserts the transfer media kit 12B in the drive device 12A at this timing, and then the data transfer program 20 is read by the image forming apparatus 1 as described above.

Next, a description is given of processes performed by the image forming apparatus 1 according to an embodiment of the present invention. First, the overall flow of operations and processes are given below.
(1) While the power of the image forming apparatus 1 is turned off, the operator installs an additional HDD in the image forming apparatus 1, and then turns on the power.
(2) When the image forming apparatus 1 is activated, the device management unit detects the additional HDD, and an instruction to insert the transfer media kit 12B is displayed on the operations panel 11.
(3) The operator inserts the transfer media kit 12B into the drive device 12A.
(4) The operator presses the execution start button on the operations panel 11.
(5) The data transfer process is performed.
(6) A process end report is displayed on the operations panel 11.

As described above, the process is performed as follows. (1) The operator turns on the power of the image forming apparatus 1 after installing the additional HDD. (2) The device management unit (detecting unit) of the image forming apparatus 1 detects the additionally installed HDD 17 and the display device 11B (display unit) displays a wizard screen page relevant to the additional HDD 17. The wizard screen page displays a message instructing to “insert the transfer media kit 12B when adding a new program”. (3) The operator inserts the transfer media kit 12B into the drive device 12A. (4) The operator presses the execution start button. (5) The image forming apparatus 1 reads the data transfer program 20 (data transfer unit), and performs processes of transferring the existing data and installing additional programs, etc. (6) A process end report is sent to the display device 11B.

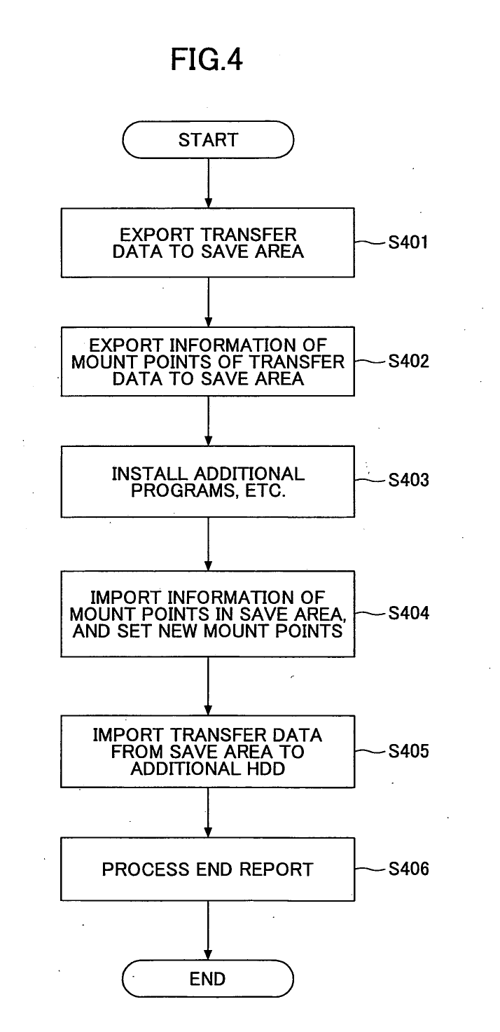

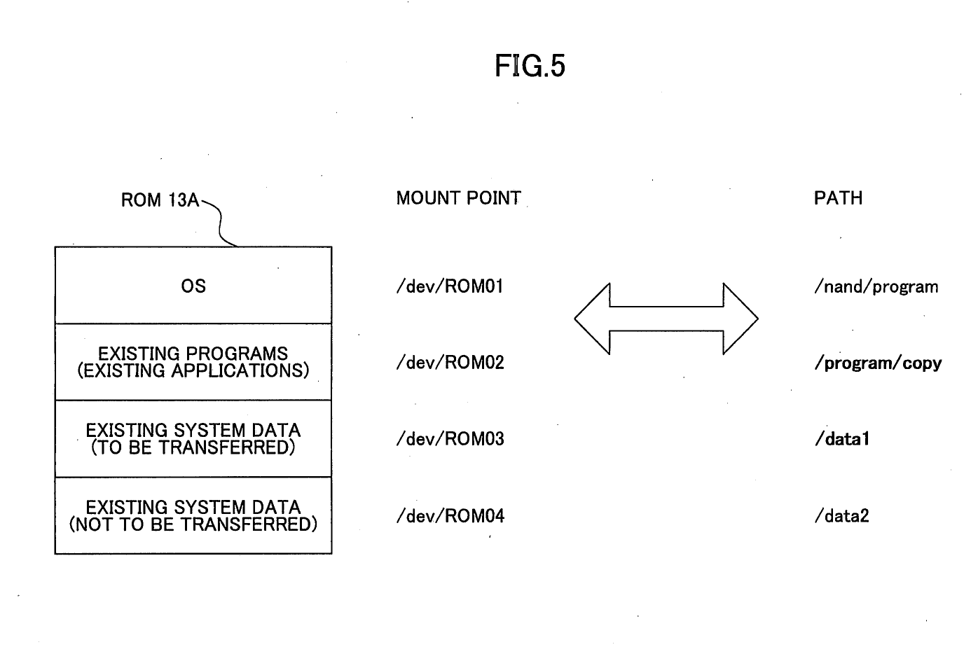

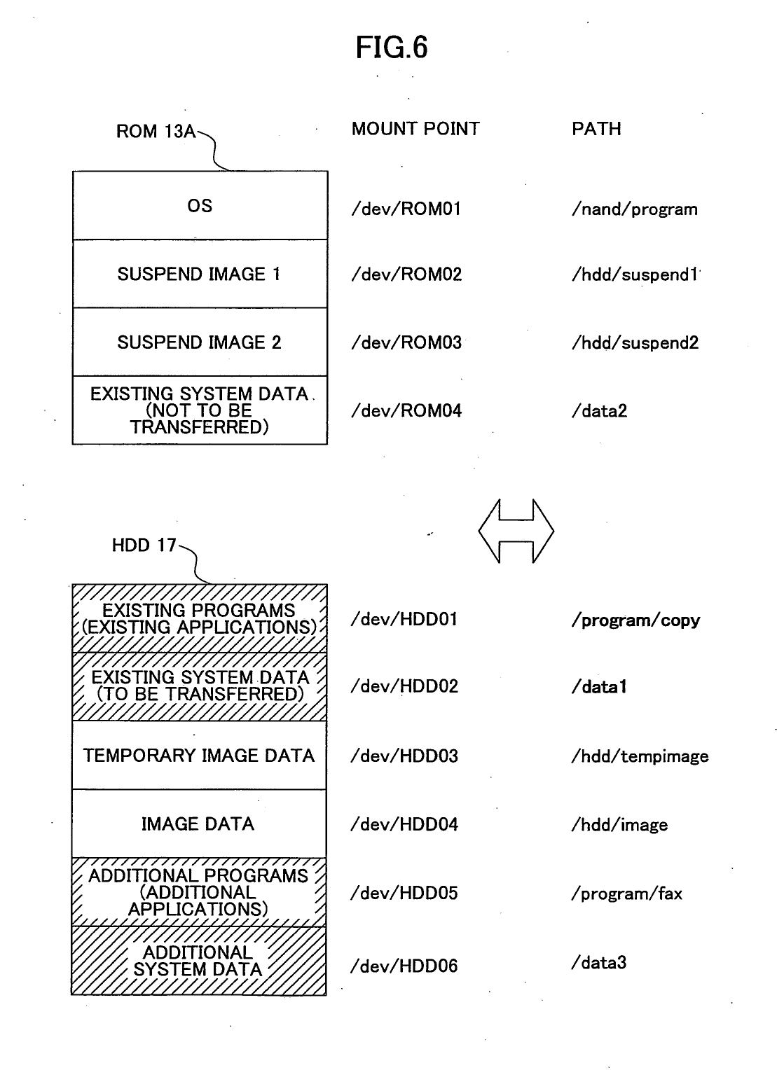

A description is given of the process of transferring data performed by the image forming apparatus 1 described in (5). FIG. 4 is a flowchart of a process performed by the image forming apparatus 1. FIG. 5 is a schematic diagram of the storage area before the additional HDD is installed. FIG. 6 is a schematic diagram of the storage area after the additional HDD is installed.

First, the transfer data (i.e., the existing programs and existing system data) is exported to the save area 23 provided in the transfer media kit 12B (step S401). As shown in FIG. 5, before installing the additional HDD, an OS, existing programs (existing applications), and existing system data are stored in the storage area of the ROM 13A. The ROM 13A is managed as file systems divided by partitions, or the ROM 13A has mount points set for areas divided by partitions. Accordingly, when an existing program is to be called, the CPU 13C specifies a path of “/program/copy”.

Next, the information of mount points relevant to the existing programs and existing system data corresponding to the transfer data, i.e., “/program/copy” and “/program/data1”, is exported to the save area 23 in the transfer media kit 12B (step S402). During the installing process, the ROM 13A is formatted, and the system configuration is reestablished (programs and data are rewritten from the beginning). Therefore, if an unexpected error occurs (such as power shutdown), the data in the ROM 13A may be lost. For this reason, the transfer data is saved in the save area 23 so that the data can be recovered in the event of an unexpected failure. The save area 23 has sufficient storage capacity for temporarily storing the transfer data.

Next, the additional programs 21 and the additional system data 22 in the transfer media kit 12B are installed into a predetermined area in the additionally installed HDD 17 (step S403). For example, as shown in FIG. 6, the additional programs 21 are stored in “/dev/HDD05” and the additional system data 22 is stored in “/dev/HDD06”.

New mount points are set for the image forming apparatus 1 in which the additional HDD 17 has been installed (step S404). Particularly, when the existing programs and existing system data are transferred from the ROM 13A to the HDD 17, these data items are mounted by the same paths as those used before the data transfer. By using the same paths regardless of whether an additional HDD is installed, there is no need to consider the location of each program (application) depending on whether an additional HDD is installed, and common execution paths can be used for, the programs. In FIG. 6, suspend image areas are provided in the ROM 13A. When the image forming apparatus 1 is additionally provided with the HDD 17, these suspend image areas are used for saving memory images for recovering at high speed. Before the additional HDD 17 is installed, “/program/copy” and “/program/data1” are mounted at “/dev/ROM02” and “/dev/ROM03”, respectively. However, after installing the additional HDD 17, the mount points “/dev/ROM02” and “/dev/ROM03” of the existing programs and existing system data need to be changed. If the mount points are not changed, and an existing program is called, “/dev/ROM02”will be referred to because the ROM is typically read before the HDD. In the present embodiment, suspend image areas are provided in the ROM 13A after transferring the data from the ROM 13A; however, these areas may be used for other purposes, or these areas may not be used, as long as the mount points are changed for the data that has been transferred. As described above, new mount points are set for the existing programs and existing system data that are to be transferred from the ROM 13A to the HDD 17 (see FIG. 6).

Next, the transfer data is imported into the HDD 17 from the save area 23 (step S405). Specifically, the existing programs and existing system data are imported into “/dev/HDD01” and “/dev/HDD02”, respectively. In step S405, “/program/copy” and “/program/data1” are mounted to “/dev/HDD01” and “/dev/HDD02”, respectively. Therefore, the CPU 13C can call the existing programs and existing system data that have been imported into the additional HDD 17 without changing the execution path of the programs. A key may be generated based on information unique to the image forming apparatus. 1 (e.g., a product serial number), and the transfer data may be encrypted before being stored in the additional HDD 17.

Accordingly, the process of adding the additional programs, etc., and the process of transferring the existing data performed by the transfer media kit 12B are completed, and finally a process end report is sent to the display device 11B (step S406). Specifically, the process end report is displayed on the wizard screen page.

The process of transferring data is performed by the data transfer unit; actually, the process of transferring data is-implemented as the CPU 13C executes a data transfer program. Furthermore, the installing process is implemented as the CPU 13C executes an installer program included in the additional programs 21.

In the following overview, a description is given of the effects of the image forming apparatus 1 according to an embodiment of the present invention.

The image forming apparatus 1 is a copier that does not have an HDD but has a low-volume ROM storing programs. The ROM stores various programs for operating the copier and various kinds of system data (user information, setting information, various parameters, etc.). The following processes are performed when installing an additional HDD and reestablishing the system in the image forming apparatus 1. When an additional HDD is detected, the wizard screen page displays a message prompting the user to input a recording medium (for example, the transfer media kit). When the data transfer program recorded in the recording medium is input, the existing data is temporarily saved in the save area. When the system is reestablished after installing the additional HDD, the existing data is transferred to a predetermined area that is secured in the HDD.

Accordingly, the system reestablishment after installing the additional HDD can be easily performed simply by inserting the transfer media kit in the image forming apparatus 1. Furthermore, the transfer data is stored in the HDD when the HDD is additionally installed. Therefore, when the additional HDD is installed, a key used for encrypting data can be generated based on information unique to the image forming apparatus 1 (e.g., a product serial number), and the transfer data can be encrypted before being stored in the additional HDD. This cannot be done in a case where programs and data are preinstalled in a HDD that is built in the apparatus in advance. Accordingly, the image forming apparatus 1 according to an embodiment of the present invention is advantageous in terms of security.

The operation of adding a new function to the image forming apparatus 1 (which is the purpose of installing an additional HDD), and the operation of transferring existing data from the ROM to the additional HDD (which is an operation needed for adding the new function), can both be easily performed simply by inserting the transfer media kit in the image forming apparatus 1.

Furthermore, in the image forming apparatus 1, the data transfer unit maintains the execution paths of the existing data (even after an additional HDD is installed), and changes the mount points where the execution paths are mounted in the predetermined area into which the existing data has been transferred from the ROM.

Accordingly, when the existing programs and existing system data are transferred from the ROM 13A to the additional HDD 17, the data is mounted with the same paths as those used before being transferred. By using the same paths regardless of the mount points, there is no need to consider the location of each program (application) depending on whether an additional HDD is installed, and common execution paths can be used for the programs. This is advantageous in developing the programs (applications).

The present invention is not limited to the specific embodiments described herein, and variations and modifications may be made without departing from the scope of the present invention.

For example, in the above embodiment, an SD card is used as a recording medium. However, the present invention is not so limited, and another type of recording medium may be used instead of the SD card. However, in consideration of using the recording medium as a transfer media kit and the light-duty operation of inserting it into the apparatus, it is advantageous to use a small recording medium that is convenient to carry around.

Furthermore, in the above embodiment, an image forming apparatus is used as an information processing apparatus to which the present invention is applied. However, the present invention is widely applicable to other systems and devices.

According to one embodiment of the present invention, an information processing apparatus, a data transfer method, and a computer-readable recording medium are provided, with which programs and data stored in a low-volume storage device can be transferred to a high-volume storage device by a simple operation when installing the additional high-volume storage device.

The present application is based on Japanese Priority Patent Application No. 2009-202004, filed on Sep. 1, 2009, the entire contents of which are hereby incorporated herein by reference.

What is claimed is:

1. An information processing apparatus comprising:
a first storage device configured to store pre-existing data including a program for operating the information processing apparatus;
a data input unit configured to input data into the information processing apparatus from outside via a recording medium;
a detecting unit configured to detect that a second storage device is additionally installed in the information processing apparatus;
a display unit configured to prompt input of the recording medium storing a data transfer program, when the detecting unit detects that the second storage device is additionally installed; and
a data transfer unit configured to transfer the pre-existing data from the first storage device to the second storage device in accordance with the data transfer program, when the data transfer program stored in the recording medium is input by the data input unit, wherein
the recording medium includes a save area in which the pre-existing data is temporarily saved, and
the data transfer unit temporarily saves the pre-existing data in the save area before transferring the pre-existing data to the second storage unit.

2. The information processing apparatus according to claim 1, wherein
the data transfer unit maintains an execution path of the pre-existing data, and changes a mount point where the execution path is mounted in a predetermined area into which the pre-existing data is transferred from the first storage device.

3. A data transfer method performed by an information processing apparatus including a first storage device configured to store pre-existing data including a program for operating the information processing apparatus, the data transfer method comprising:
inputting data into the information processing apparatus from outside via a recording medium;
detecting that a second storage device is additionally installed in the information processing apparatus;
prompting input of the recording medium recording a data transfer program, when it is detected at the detecting that the second storage device is additionally installed; and
transferring the pre-existing data from the first storage device to the second storage device in accordance with the data transfer program, when the data transfer program stored in the recording medium is input at the inputting, wherein
the transferring includes temporarily saving the pre-existing data in a save area in the recording medium before transferring the pre-existing data to the second storage unit.

4. The data transfer method according to claim 3, wherein
the transferring includes maintaining an execution path of the pre-existing data, and changing a mount point where the execution path is mounted in a predetermined area into which the pre-existing data is transferred from the first storage device.

5. A computer-readable recording medium storing a program that causes a computer to function as the information processing apparatus according to claim 1.
